(19) United States
(12) Patent Application Publication
(10) Pub. No.: US 2012/0241652 A1
(43) Pub. Date: Sep. 27, 2012

(54) RADIATION PROTECTIVE DEVICE

(75) Inventor: Richard Jeschke, Dachau (DE)

(73) Assignee: MAVIG GMBH, Munchen (DE)

(21) Appl. No.: 13/513,933

(22) PCT Filed: Dec. 8, 2010
(86) PCT No.: PCT/EP2010/069184

§ 371 Date: Jun. 5, 2012

(30) Foreign Application Priority Data
Dec. 8, 2009 (DE) 10 2009 057 366.6

(51) Int. Cl. G21F 3/00

(52) U.S. Cl. 250/519.1

(57) ABSTRACT

According to the invention, a radiation protective device for attachment to a patient table is provided. The radiation protective device comprises a carrier and a shielding element provided at the carrier, wherein the shielding element is mounted at the carrier by means of at least one double joint such that the shielding element is movable at least between a folded-up position and a folded-down position.

The present invention relates to a radiation protective device, in particular a protective device for shielding the X-ray radiation emitted by an X-ray radiation source provided, for example, for the use in an angiographic workstation.

In order to keep the radiation exposure caused by radioscopy as low as possible for the people involved, it has been known for a long time to use radiation protective clothing. Although this radiation protective clothing offers a very effective protection against increased radiation exposure in certain cases, the protection to be achieved with it in so-called angiographic workstations is only insufficient. A physician's radiation exposure in such a workstation is particularly high due to the multidirectional nature of the radiation so that a so-called lower-body protective arrangement is used in addition to wearing X-ray protective clothing.

Such a lower-body protective arrangement is known, for example, from EP 1 613 217 B1. According to this patent, a lower-body protective arrangement which can be laterally arranged on a patient table consists of a shielding mat in the form of a lead rubber mat or lead foil stratified into PVC, wherein said shielding mat has a lead equivalent of 0.5 mm, extends from the table level of the patient table to the floor and shields the lower extremities not covered by the X-ray protective clothing from scattered radiation. In this connection, the lead equivalent describes the absorption behaviour of a body, in particular a laminate, which exhibits the same shielding from X-rays as a lead plate of the respective thickness.

The lower-body protective arrangement known from EP 1 613 217 B1 comprises a plurality of PVC lead rubber slats arranged laterally side by side and so as to at least partly overlap. The slats are fixed to a carrier rail at which additionally an upper component can be arranged which offers additional protection above the patient table.

In this case, the upper component is configured as an attachment that can be fixed to the carrier rail and again removed therefrom.

It is a disadvantage of this known lower-body protective arrangement that the upper component projecting upwards from the patient table often impedes the access to the patient on the patient table or blocks the patient table. Since this attachment is often a hindrance and only required when X-rays actually are being emitted, the attachment has often to be removed and then reattached. This procedure complicates the workflow in the operation theatre since, i.a., the removed attachment must be put somewhere. Furthermore, the removal of the attachment exposes the carrier rail together with its fastening devices for the attachment and a patient could get injured by the rail or the fastening devices.

Accordingly, it is an object of the present invention to provide a radiation protective device that takes the aforementioned problems into account. It is in particular an object of the present invention to provide an effective radiation protective device which, on the one hand, ensures a safe protection and, on the other hand, does not impede or complicate the workflow during an examination. This object is achieved by a radiation protective device according to claim 1.

According to the invention, a radiation protective device for attachment to a patient table is provided. The radiation protective device comprises a carrier and a shielding element provided at the carrier, wherein the shielding element is mounted at the carrier by means of at least one double joint such that the shielding element is movable at least between a folded-up position and a folded-down position. In the folded-up position, the shielding element provides sufficient protection against scattered rays originating from a patient lying on a patient table. When this protection is not being required, for instance because the X-ray apparatus is not emitting radiation, the shielding element can be easily brought into a folded-down position. In this folded-down position, the shielding element is arranged at the patient table such that it does not impede the access to the patient table or rather to a patient lying on said patient table.

It is further preferred that the carrier is essentially covered by the shielding element in the folded-down position. To this end, the shielding element can comprise an optionally flexible extension that does not necessarily have to be radiopaque. This prevents the patient from getting injured by the carrier or fastening devices provided on the carrier. Furthermore, the carrier as well as the mechanics provided thereon are thereby protected against contamination.

Preferably, the shielding element of the radiation protective device according to the invention comprises exactly two stable positions, namely the folded-up and folded-down positions, in which it is fixable. According to an alternative variant, the shielding element can be fixed in several positions or as many positions as desired between the folded-up position and the folded-down position.

It is preferred that the double joint is attached to the carrier such that at least one swivelling axis of the double joint is blocked in the folded-up position of the shielding element. The shielding element is thus fixed in the folded-up position by blocking the double joint axis without additional fixing means being required.

Preferably, the height of the shielding element is adjustable at least in the folded-up position. The shielding element can thus be adapted to a given situation, for example the dimensions of a patient. It is further preferred that the shielding element is pivotable and/or inclinable at least in its folded-up position. This is also meant to optimize the protection depending on the respective situation.

According to a particularly preferable embodiment of the present invention, the double joint is configured as a double joint pin. Even though the present invention can be realized with a single double joint pin, it is preferred that the shielding element is mounted at the carrier by means of at least two double joint pins. In this connection, it is preferred that the at least two double joint pins are passed through through-holes in the carrier which are provided for this purpose. The different positions of the shielding element can then be realized by displacing the double joint pins in the through-holes of the carrier.

The double joint pins preferably comprise three pin portions respectively articulated to each other. The length of a first pin end portion is greater than the thickness of the carrier and the length of a second pin end portion is preferably smaller than the thickness of the carrier. Furthermore, a central pin portion preferably has a length which is greater than the distance of the through-holes in the carrier from the edge of the carrier. This essentially permits folding of the double joint pin around the carrier.

Preferably, each of the two joints of the double joint enables a pivoting angle in the range between 70° and 110°. In other words, in the case of the double joint pins, the pin sections articulated to each other can be lengthwise aligned or assume an angle substantially perpendicular to each other.

According to a preferred embodiment of the radiation protective device of the present invention, further at least one undertable radiation protective element is attachable at the carrier in a detachable way. Preferably, a plurality of undertable radiation protective elements are arranged for this purpose side by side and so as to overlap. In this connection, the undertable radiation protective element is preferably suspended so as to be able to swing. The shielding element of the radiation protective device is preferably angled in its upper region.

Preferred embodiments of the radiation protective device according to the present invention will be described in the following in more detail with reference to the Figures.

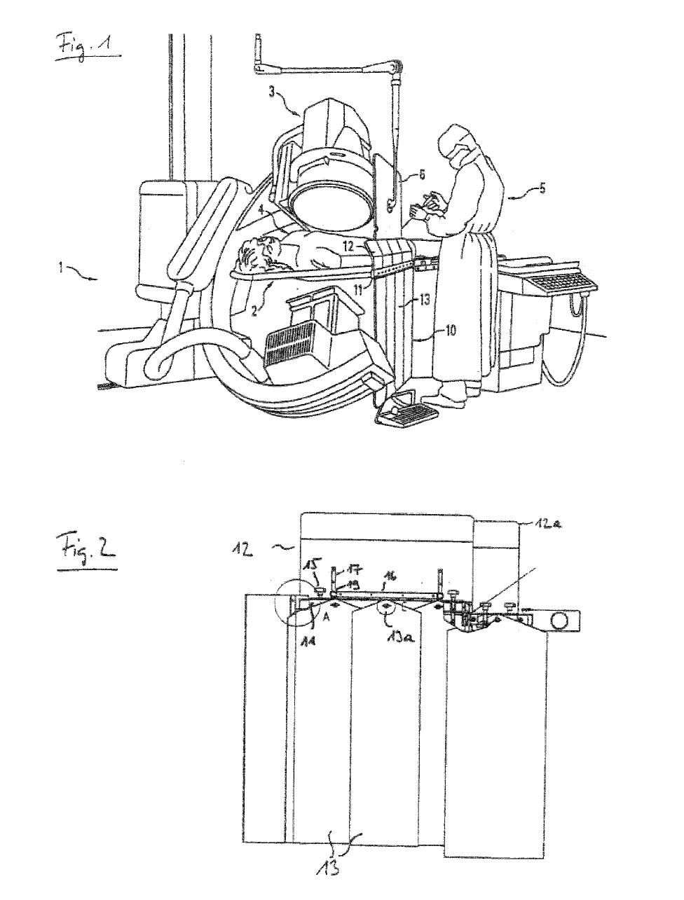

FIG. 1 shows an angiographic workstation comprising a radiation protective arrangement according to the prior art;

FIG. 2 shows a front view of a preferred embodiment of the radiation protective device according to the present invention;

FIG. 3 shows a side view of a preferred embodiment of the radiation protective device according to the present invention;

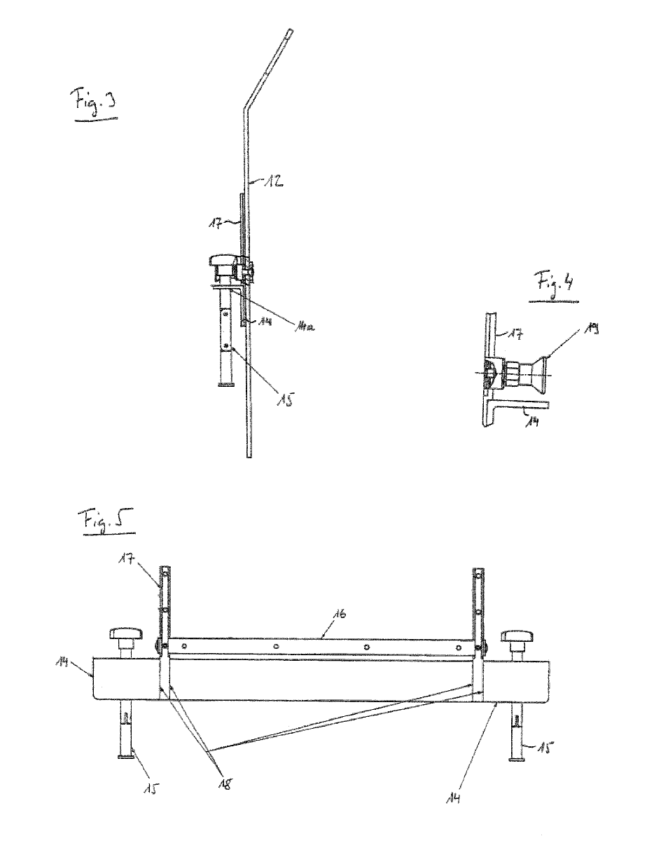

FIG. 4 shows a detail of FIG. 3;

FIG. 5 shows a rear view of the radiation protective device of FIG. 3 without a shielding element;

FIG. 6 shows a double joint pin to be used in the radiation protective device according to the present invention;

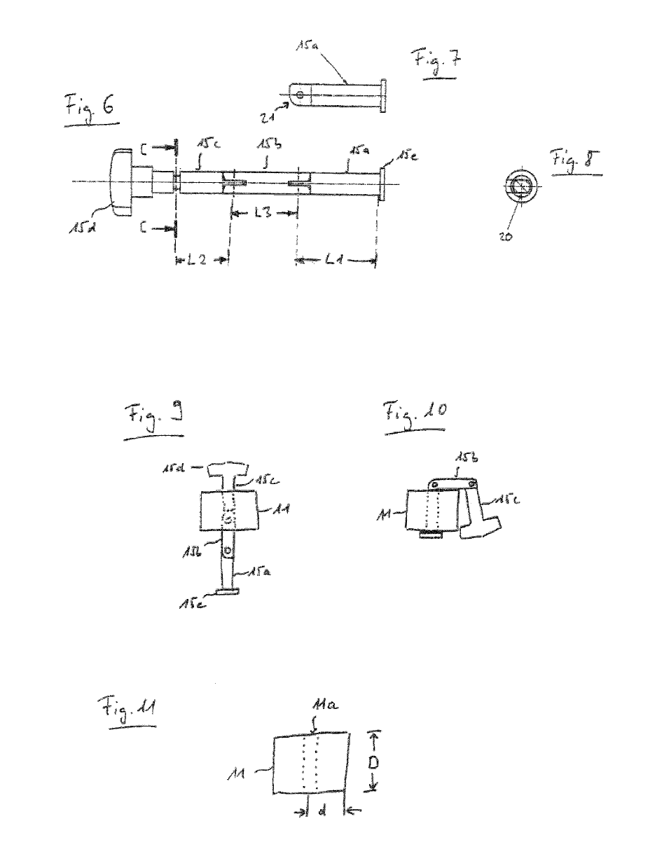

FIG. 7 shows a pin end portion of the double joint pin of FIG. 6;

FIG. 8 shows a section along C-C in FIG. 6;

FIG. 9 shows a schematic representation of the double joint pin in a guide hole of a carrier in the folded-up position;

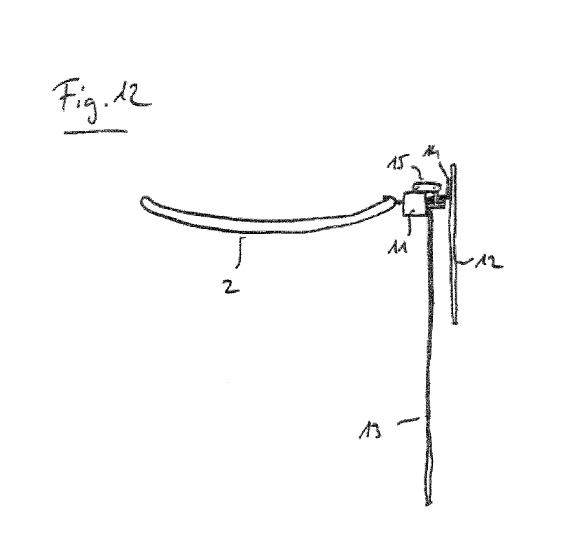

FIG. 10 shows a schematic representation of the double joint pin in the guide hole of the carrier in the folded-down position;

FIG. 11 shows a side view of the carrier; and

FIG. 12 shows a preferred embodiment of the radiation protective device according to the present invention in the folded-down position.

FIG. 1 shows an angiographic workstation generally denoted by reference sign 1, whose essential components are a patient table 2 adjustable in height as well as an X-ray arrangement 3. The X-ray arrangement 3 is pivot-mounted to ensure an adjustment of the X-ray generator to the patient 4 as flexible as possible. This entails that the X-ray radiation and the respective scattered rays can exit in the most different directions.

Therefore, in order to be able to protect a person 5 working at the workstation 1 against this radiation as comprehensively as possible, additional radiation protective measures are provided besides the radiation protective clothing of the person 5. In the present case, these additional measures are a radiation protective shield 6, which is meant to pennit shielding of the upper body of the attending physician 5 as well as of his/her head. Moreover, a lower-body protective arrangement 10 is provided, which is known, for example, from EP 1 613 217 B1. This lower-body protective arrangement 10, which is fixed to the lateral area of the treatment table 2, consists of an upper part 12 arranged at a carrier rail 11 fixed to the table 2 as well as of a plurality of slats 13 fixed to the bottom side of the carrier rail 11 and laterally arranged side by side so as to overlap. The overlapping arrangement of the slats 13 entails a particularly high flexibility of the arrangement, which permits a very effective radiation protection.

While the radiation protective screen 6 can be displaced with a simple hand movement, the upper part 12, which is in the way when the patient 4 is to be placed on the patient table 2, can only be completely removed. This is relatively complicated and makes working at such an angiographic workstation 1 difficult. In order to take this problem into account, the present invention provides a shielding element instead of the known upper part 12, said shielding element being mounted to a carrier or the carrier rail 11 by means of at least one double joint in such a way that it is movable at least between a folded-up position according to FIG. 2 and a folded-down position according to FIG. 12. In this way, the shielding element can be folded down with a simple hand movement, which then enables easier access to the patient table 2 or rather the patient 4. While in FIG. 12 only access to the patient table 4 was provided by folding down the to shielding element, it is possible to provide additionally a preferably flexible extension, which is not illustrated, at the shielding element 12, said flexible extension covering the carrier 11 and the double joint pins in the folded-down condition and thus protectimg these components against contamination and the patient against injuries.

FIG. 3 depicts a side view of a radiation protective device according to the invention without a carrier or a carrier rail. The radiation protective device essentially comprises a shielding element 12 connected to two double joint pins 15 by means of an angle bracket 14. The shielding element is preferably configured to be angled in its upper area. Preferably, the angled area of the shielding element 12 is inclined towards the patient in order to shield radiation from the patient more reliably. The carrier rail 11 (not illustrated in FIG. 3) comprises two corresponding guide apertures 11a (cf. FIG. 11) accommodating the double joint pins 15. The shielding element 12 of the radiation protective device can be moved between a folded-up position and a folded-down position by displacing the double joint pins 15 in the guide apertures 11a of the carrier or the carrier rail 11, as illustrated in the schematic representation according to FIGS. 9 and 10.

The double joint pin 15 comprises a first pin end portion 15a, a second pin end portion 15c and a central pin portion 15b articulated to these two pin end portions. A projection 15e is provided at the end of the first pin end portion 15a. The second pin end portion 15c merges into a grip portion 15d. The double joint pin 15 is guided in the through-hole 11a of the carrier 11 (cf. FIG. 11) such that it is displaceable between a first position illustrated in FIG. 9 and a second position illustrated in FIG. 10. In the position illustrated in FIG. 9, the double joint pin 15 is substantially vertically supported in the carrier 11. The shielding element 12 fixed to the double joint pin 15 is thereby maintained in the folded-up position as illustrated in FIG. 3.

The double joint pins 15 can be drawn upwards from the position illustrated in FIG. 9 by drawing at the grip portions 15d thereof. Such a movement is limited or stopped by the projections 15e provided at the first pin end portions 15a. The central pin portion 15b and the second pin end portion 15c can then be angled such that the double joint pin 15 is essentially folded around the carrier 11 as shown in FIG. 10. The shielding element 12 fixed to the double joint pin 15 is thereby converted from the folded-up position illustrated in FIG. 3 into a folded-down position, whereby access is given to the patient table or rather to the patient. FIG. 12 schematically illustrates a shielding element 12 according to the present invention in the folded-down position.

It is particularly advantageous for the purpose of this functionality that the double joint pin 15 has specific dimensions. As depicted in FIG. 6, the first and second pin end portions 15a and 15c have a length L1 and L2, respectively, and the central pin portion 15b has a length L3. As schematically illustrated in FIG. 11, the carrier 11 has a thickness D, wherein the distance of the through-hole 11a from the edge of the carrier is d. It is advantageous for the purpose of folding the double joint pin 15 according to FIG. 10 that the length L1 of the first pin end portion 15a is greater than the thickness D of the carrier 11 and the length L3 of the central pin portion 15b is greater than the distance d of the through-hole from the edge of the carrier 11. It is further preferred that the length L2 of the second pin end portion 15c is smaller than the thickness D of the carrier 11. The joint connecting the central pin portion 15b to the second pin end portion 15c is thereby blocked by the guide aperture 11a of the carrier 11 in the situation illustrated in FIG. 9.

Since the shielding element 12 is essentially intended to be folded from the folded-up position in one direction only, namely away from the patient table, it is further preferred that each of the two joints of the double joint pin permits pivoting angles in the range between 70° and 110°, particularly preferably of about 90°. In other words, the double joint pin 15 should be able to be folded from the substantially straight position by about 90° at each joint in one direction only (cf. FIG. 10). To this end, the joint-forming ends 21 of the pin end portions 15a and 15c are asymmetrically shaped, as depicted in FIG. 7, so that bending of the adjacent pin portions essentially is possible in one direction only. In order to ensure a corresponding orientation of the joint pin 15 with respect to the shielding element 12, the second pin end portion 15c in parts exhibits a cross-section having, for example, two substantially parallel side surfaces as depicted in FIG. 8. A corresponding aperture 14a in the angle bracket 14 (cf. FIG. 3) in which the double pin joint 15 is accommodated prevents the double joint pin 15 from turning out of position in the aperture 14a.

In a preferred embodiment, the shielding element is connected to the angle bracket 14 via a guide rail 17. FIG. 5 depicts two vertical guide rails 17 which are directly welded to the angle bracket 14, as indicated by reference sign 18. Furthermore, a horizontal guide 16 is provided. The horizontal guide 16 can slide upwards and downwards along the vertical guides and be fixed to them by means of a locking bolt 19 (cf. FIG. 4). It is thereby possible to additionally adjust the height of the shielding element 12 in the folded-up position. Instead of the separate apertures for the locking bolt 19 in the guide rails 17, long holes can alternatively be provided in the guide rails 17. This renders the height of the shielding element 12 continuously adjustable. The long holes can additionally comprise a connecting-link guide so that the shielding element 12 can additionally be rotated or tilted.

FIG. 2 illustrates a front view of a radiation protective device according to the invention, i.e. as seen from the side of the physician. In this case, the shielding element 12 is mounted in its folded-up position by means of the double joint pins 15 which are fixed in the carrier 11. This Figure further depicts the horizontal guide rail 16 as well as the vertical guide rails 17. Thus, the height of the shielding element 12 can be easily adjusted in the folded-up position from the side of the physician by means of the locking bolts 19. When the shielding element 12 is to be folded down from the position shown in FIG. 2, the physician must only draw upwards the two double joint pins 15 so that the shielding element 12 folds over to the front, i.e. to himself/herself. After this simple procedure, the physician has free access to the patient without being impeded by the shielding element 12, as illustrated in FIG. 12.

As illustrated in FIG. 12, an additional shielding element 12a may be provided in addition to the shielding element 12, wherein said additional shielding element 12a is attached in an analogous way and can also be folded down. Furthermore, a plurality of slats 13 can be provided which are arranged at the bottom side of the carrier rail 11 laterally side by side and so as to overlap. According to the invention, each of the individual slats 13 is suspended from the carrier rail 11 by means of fixing means 13a. A swingable suspension is particularly preferred. An attachment permitting the slats to be fixed or released without tools is preferred. This can be realized, for example, by means of ball locking bolts or snap fasteners. Alternatively, a keyhole fixation or turn-lock fastener as typically used in tarpaulins for heavy goods vehicles is also possible.

Both the protective slats 13 and the shielding elements 12 and 12a preferably have a lead equivalent of 0.5 mm. The shielding element and the protective elements can comprise, for example, a lead rubber mat or lead foil stratified into PVC. However, other materials providing a corresponding protection can be used as well.

The radiation protective device according to the present invention, on the one hand, provides effective protection against X-ray radiation and other rays and, on the other hand, enables a smooth workflow in that it can be easily folded away by hand. This considerably facilitates the physician's access to the patient.

1. A radiation protective device for attachment to a patient table, wherein the device comprises a carrier and a shielding element provided at the carrier, wherein the shielding element is mounted at the carrier by means of at least one double joint such that the shielding element is movable at least between a folded-up position and a folded-down position.

2. The radiation protective device according to claim 1, wherein the double joint is configured as a double joint pin.

3. The radiation protective device according to claim 1, wherein the double joint is attached to the carrier such that at least one swivelling axis of the double joint is blocked in the folded-up position.

4. The radiation protective device according to claim 1, wherein the shielding element is adjustable in height and/or pivotable and/or inclinable at least in its folded-up position.

5. The radiation protective device according to claim 2, wherein the at least one double joint pin is passed through a through-hole in the carrier.

6. The radiation protective device according to claim 5, wherein the at least one double joint pin comprise three pin portions articulated to each other, wherein a first pin end portion has a length (L1) which is greater than the thickness (D) of the carrier, wherein a central pin portion preferably has a length (L3) which is greater than the distance (d) of the through-hole from the edge of the carrier, and wherein a second pin end portion preferably has a length (L2) which is smaller than the thickness (D) of the carrier.

7. The radiation protective device according to claim 1, wherein each of the two joints of the at least one double joint pin permits pivoting angles in the range between 70° and 110°.

8. The radiation protective device according to claim 1, wherein further at least one undertable radiation protective element is attachable at the carrier in a detachable way and preferably a plurality of undertable radiation protective elements are attachable at the carrier in a detachable way side by side and so as to overlap, wherein the undertable radiation protective element is preferably swingably suspended.

9. The radiation protective device according to claim 1, wherein the shielding element is angled.

10. The radiation protective device according to claim 1, wherein the carrier is essentially covered by the shielding element in the folded-down position.
